(19) United States
(12) Patent Application Publication
(10) Pub. No.: US 2019/0052362 A1
(43) Pub. Date: Feb. 14, 2019

(54) Method And System For A Free Space CWDM MUX/DEMUX For Integration With A Grating Coupler Based Silicon Photonics Platform

(71) Applicant: Luxtera, Inc., Carlsbad, CA (US)

(72) Inventors: Mark Peterson, San Diego, CA (US); Subal Sahni, La Jolla, CA (US); Peter De Dobbelaere, San Diego, CA (US)

(21) Appl. No.: 16/100,727

(22) Filed: Aug. 10, 2018

Related U.S. Application Data
(60) Provisional application No. 62/543,679, filed on Aug. 10, 2017.
(60) Provisional application No. 62/545,652, filed on Aug. 15, 2017.

(51) Int. Cl. H04B 10/25; G02B 27/09; G02B 6/38; G02B 27/10; G02B 5/20; H04J 14/02; G02B 6/02

(52) U.S. Cl. CPC H04B 10/25; G02B 27/0961; G02B 27/0977; G02B 6/02057; G02B 27/1006; G02B 5/20; H04J 14/0278; G02B 6/381

(57) ABSTRACT

Methods and systems for a free space CWDM MUX/DEMUX for integration with a grating coupler based silicon platform may include an optical assembly comprising a lens array and a plurality of thin film filter splitters having angled reflective surfaces. The optical assembly may be operable to receive an input optical signal comprising a plurality of optical signals at different wavelengths via an optical fiber, focus the input optical signal onto a first thin film filter splitter, reflect a first of the optical signals into the lens array and passing others to a second thin film filter splitter, and reflect a second optical signal into the lens array and passing others to a third of the plurality of thin film filter splitters.

### CROSS-REFERENCE TO RELATED APPLICATIONS/INCORPORATION BY REFERENCE

This application claims priority to and the benefit of U.S. Provisional Application No. 62/543,679 filed on Aug. 10, 2017, and U.S. Provisional Application No. 62/545,652 filed on Aug. 15, 2017, each which is hereby incorporated herein by reference in its entirety.

### FIELD

Aspects of the present disclosure relate to electronic components. More specifically, certain implementations of the present disclosure relate to methods and systems for a free space CWDM MUX/DEMUX for integration with a grating coupler based silicon platform.

### BACKGROUND

Conventional approaches for CWDM multiplexing and demultiplexing may be costly, cumbersome, and/or inefficient—e.g., they may be complex and/or time consuming, and/or may have limited responsivity due to losses.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for a free space CWDM MUX/DEMUX for integration with a grating coupler based silicon platform, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram of a photonically-enabled integrated circuit with a free space CWDM MUX/DEMUX for integration with a grating coupler based silicon platform, in accordance with an example embodiment of the disclosure.

FIG. 2 illustrates thin film filter external MUX/DEMUX for coupling to grating couplers on a photonic chip, in accordance with an example embodiment of the disclosure.

FIGS. 3A-3C illustrates top, side, and side detail views of a thin film filter external MUX/DEMUX for coupling to grating couplers on a photonic chip, in accordance with an example embodiment of the disclosure.

FIG. 4 illustrates a thin-film filter external MUX/DEMUX with both horizontal and vertical plane channel separation, in accordance with an example embodiment of the disclosure.

FIG. 5 illustrates an oblique view of a thin-film filter external MUX/DEMUX with both horizontal and vertical plane channel separation, in accordance with an example embodiment of the disclosure.

FIGS. 6A-6C illustrates top and side views of a thin-film filter external MUX/DEMUX with both horizontal and vertical plane channel separation, in accordance with an example embodiment of the disclosure.

FIG. 7 illustrates a free-space MUX/DEMUX with thin film filter splitter cubes, in accordance with an example embodiment of the disclosure.

FIG. 8 illustrates a side view of a free-space MUX/DEMUX with thin film filters, in accordance with an example embodiment of the disclosure.

FIGS. 9A-9B illustrate side and oblique angle views of a free-space MUX/DEMUX with angled facet thin film filter splitter cubes, in accordance with an example embodiment of the disclosure.

FIGS. 10A-10F illustrate an example process for fabricating angled thin film filter splitters, in accordance with an example embodiment of the disclosure.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry or a device is “operable” to perform a function whenever the circuitry or device comprises the necessary hardware and code (if any is necessary) to perform the function, regardless of whether performance of the function is disabled or not enabled (e.g., by a user-configurable setting, factory trim, etc.).

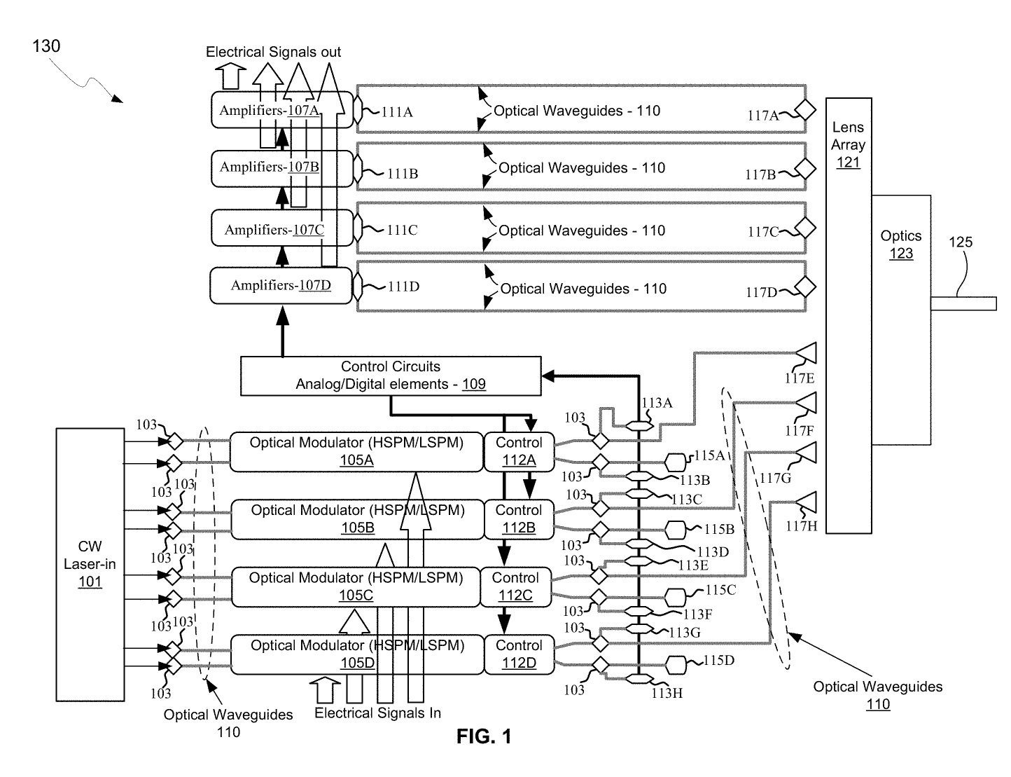

FIG. 1 is a block diagram of a photonically-enabled integrated circuit with a free space CWDM MUX/DEMUX for integration with a grating coupler based silicon platform, in accordance with an example embodiment of the disclosure. Referring to FIG. 1, there are shown optoelectronic devices on a photonically-enabled integrated circuit 130 comprising optical modulators 105A-105D, photodiodes 111A-111D, monitor photodiodes 113A-113H, and optical devices comprising couplers 103, optical terminations 115A-115D, and grating couplers 117A-117H. There are also shown electrical devices and circuits comprising amplifiers 107A-107D, analog and digital control circuits 109, and control sections 112A-112D. The amplifiers 107A-107D may comprise transimpedance and limiting amplifiers (TIA/LAs), for example.

In an example scenario, the photonically-enabled integrated circuit 130 comprises a CMOS photonics die with laser assemblies 101 coupled to the top surface of the IC 130. The CW Laser In 101 comprises one or more laser assemblies comprising a plurality of semiconductor lasers with isolators, lenses, and/or rotators for directing one or more continuous wave (CW) optical signals to the couplers 103. In an example scenario, the laser assemblies may be multiple laser modules within one laser assembly or may comprise a laser array in a single module, for example, where a pair of lasers is coupled to each optical modulator, with one laser to each arm of the modulator, thereby providing redundant light sources for each transceiver. By coupling redundant lasers to each modulator, yields may be increased, particularly with the difficulty of testing lasers prior to assembly with the CMOS die 130.

The photonically enabled integrated circuit 130 may comprise a single chip, or may be integrated on a plurality of die, such as one or more electronics die and one or more photonics die.

Optical signals are communicated between optical and optoelectronic devices via optical waveguides 110 fabricated in the photonically-enabled integrated circuit 130. Single-mode or multi-mode waveguides may be used in photonic integrated circuits. Single-mode operation enables direct connection to optical signal processing and networking elements. The term “single-mode” may be used for waveguides that support a single mode for each of the two polarizations, transverse-electric (TE) and transverse-magnetic (TM), or for waveguides that are truly single mode and only support one mode whose polarization is TE, which comprises an electric field parallel to the substrate supporting the waveguides. Two typical waveguide cross-sections that are utilized comprise strip waveguides and rib waveguides. Strip waveguides typically comprise a rectangular cross-section, whereas rib waveguides comprise a rib section on top of a waveguide slab. Of course, other waveguide cross section types are also contemplated and within the scope of the disclosure.

The optical modulators 105A-105D comprise Mach-Zehnder or ring modulators, for example, and enable the modulation of the continuous wave (CW) laser input signal. The optical modulators 105A-105D may comprise high-speed and low-speed phase modulation sections and are controlled by the control sections 112A-112D. The high-speed phase modulation section of the optical modulators 105A-105D may modulate a CW light source signal with a data signal. The low-speed phase modulation section of the optical modulators 105A-105D may compensate for slowly varying phase factors such as those induced by mismatch between the waveguides, waveguide temperature, or waveguide stress and is referred to as the passive phase, or the passive biasing of the MZI.

In an example scenario, the high-speed optical phase modulators may operate based on the free carrier dispersion effect and may demonstrate a high overlap between the free carrier modulation region and the optical mode. High-speed phase modulation of an optical mode propagating in a waveguide is the building block of several types of signal encoding used for high data rate optical communications. Speed in the several Gb/s may be required to sustain the high data rates used in modern optical links and can be achieved in integrated Si photonics by modulating the depletion region of a PN junction placed across the waveguide carrying the optical beam. In order to increase the modulation efficiency and minimize the loss, the overlap between the optical mode and the depletion region of the PN junction is optimized.

The outputs of the optical modulators 105A-105D may be optically coupled via the waveguides 110 to the grating couplers 117E-117H. The couplers 103 may comprise four-port optical couplers, for example, and may be utilized to sample or split the optical signals generated by the optical modulators 105A-105D, with the sampled signals being measured by the monitor photodiodes 113A-113H. The unused branches of the directional couplers 103 may be terminated by optical terminations 115A-115D to avoid back reflections of unwanted signals.

The grating couplers 117A-117H comprise optical gratings that enable coupling of light into and out of the photonically-enabled integrated circuit 130. The grating couplers 117A-117D may be utilized to couple light received from optical fibers via optical couplers with integrated optics into the photonically-enabled integrated circuit 130, and the grating couplers 117E-117H may be utilized to couple light from the photonically-enabled integrated circuit 130 into optical fibers. The grating couplers 117A-117H may comprise single polarization grating couplers (SPGC) and/or polarization splitting grating couplers (PSGC). In instances where a PSGC is utilized, two input, or output, waveguides may be utilized.

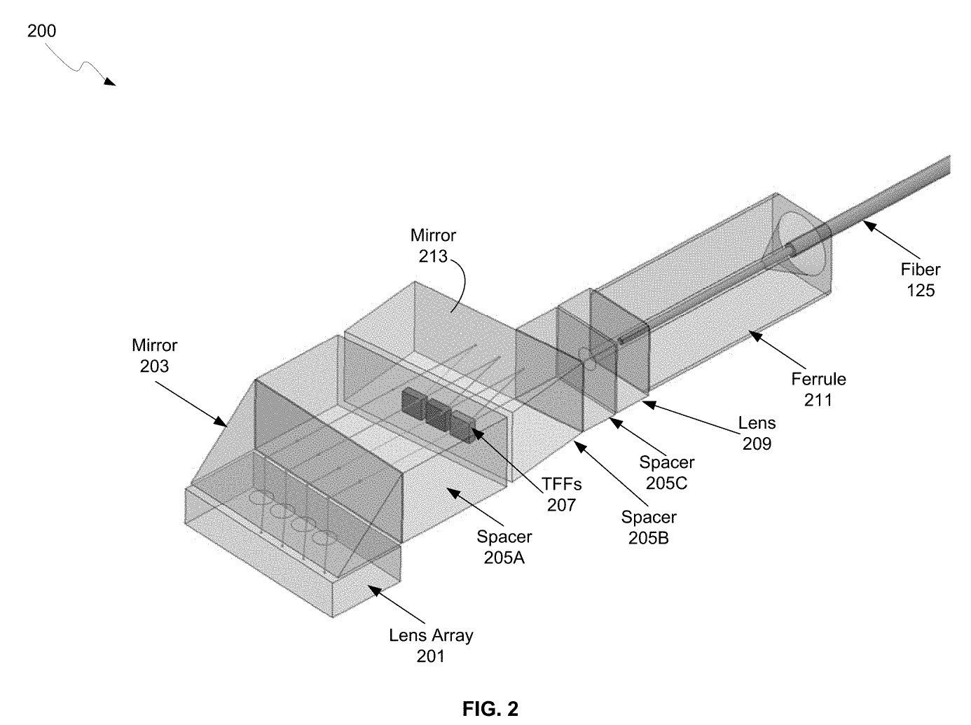

The optical fibers may be coupled to the IC 130 using lens array 121 and an optics assembly 123 comprising lenses, spacers, mirrors, and thin film filters, for example. These structures are described further with respect to FIGS. 2-4.

The photodiodes 111A-111D may convert optical signals received from the grating couplers 117A-117D into electrical signals that are communicated to the amplifiers 107A-107D for processing. In another embodiment of the disclosure, the photodiodes 111A-111D may comprise high-speed heterojunction phototransistors, for example, and may comprise germanium (Ge) in the collector and base regions for absorption in the 1.3-1.6 μm optical wavelength range, and may be integrated on a CMOS silicon-on-insulator (SOI) wafer. In another example scenario, the photodiodes may comprise 4-port high-speed photodiodes enabling the reception of different channels from two different polarization splitting grating couplers (PSGCs).

The analog and digital control circuits 109 may control gain levels or other parameters in the operation of the amplifiers 107A-107D, which may then communicate electrical signals off the photonically-enabled integrated circuit 130. The control sections 112A-112D comprise electronic circuitry that enable modulation of the CW laser signal received from the couplers 103. The optical modulators 105A-105D may require high-speed electrical signals to modulate the refractive index in respective branches of a Mach-Zehnder interferometer (MZI), for example. In an example embodiment, the control sections 112A-112D may include sink and/or source driver electronics that may enable a bidirectional link utilizing a single laser.

In operation, the photonically-enabled integrated circuit 130 may be operable to transmit and/or receive and process optical signals. Optical signals may be received from optical fibers by the grating couplers 117A-117D and converted to electrical signals by the photodetectors 111A-111D. The electrical signals may be amplified by transimpedance amplifiers in the amplifiers 107A-107D, for example, and subsequently communicated to other electronic circuitry, not shown, in the photonically-enabled integrated circuit 130.

Integrated photonics platforms allow the full functionality of an optical transceiver to be integrated on a single chip. An optical transceiver chip contains optoelectronic circuits that create and process the optical/electrical signals on the transmitter (Tx) and the receiver (Rx) sides, as well as optical interfaces that couple the optical signals to and from a fiber. The signal processing functionality may include modulating the optical carrier, detecting the optical signal, splitting or combining data streams, and multiplexing or demultiplexing data on carriers with different wavelengths, and equalizing signals for reducing and/or eliminating inter-symbol interference (ISI), which may be a common impairment in optical communication systems.

The photonically-enabled integrated circuit 130 may comprise a single electronics/photonics CMOS die/chip or may comprise separate CMOS die for the photonics and electronics functions. The photonically-enabled integrated circuit 130 may be coupled to a fiber using the lens array 121 and optics 123, which are shown further with respect to FIGS. 2-4.

The integration of CWDM with 20 nm spacing with grating coupler-based silicon photonics may be difficult because of the wavelength bandwidth of the grating couplers. This may be overcome by using an external MUX/DEMUX using planar lightwave circuit (PLC) technology and/or thin film filters (TFF).

FIG. 2 illustrates a thin film filter external MUX/DEMUX for coupling to grating couplers on a photonic chip, in accordance with an example embodiment of the disclosure. Referring to FIG. 2, there is shown an external MUX/DEMUX optical assembly 200 comprising a lens array 201, a mirror 203, spacers 205A-205C, thin film filters 207, a lens 209, a fiber ferrule 211. There is also shown optical fiber 125 for coupling optical signals to and/or from the optical assembly 200. The lens array 201 may comprise a plurality of silicon lenses, for example, that are operable to focus optical signals at a desired spot with desired beam width and angle from normal. The spacers 205A-205C may comprise glass or similar material that is optically transparent with a desired index of refraction and allows for accurate thickness control.

The fiber ferrule 211 may comprise a mechanical structure for affixing fiber 125 to the optical assembly 200, and may be coupled to the lens 209, which may comprise silicon, for example. The ferrule 211 may comprise metal or other rigid material for providing mechanical strength to the structure and confinement of the fiber 125. The lens 209 may be operable to focus light from the fiber 125 to the thin-film filters 207 in the first spacer 205C, or to focus optical signals received from the thin-film filter 207 into the fiber 125.

A combination of spacers 205A-205C and thin film filters 207 creates the MUX/DEMUX functions of the assembly 200 and lens 209 couples the light in the fiber 125 held in the ferrule 211. The spacer 205C coupled to the fiber ferrule may comprise a partially coated backside with a high reflectivity mirror 213 to eliminate back-coupling of signals into the fiber 125 and to reflect signals back to the TFFs 207. The spacers 205A-205C may have precise angles and thicknesses for directing optical signals to desired lenses in the silicon lens array 201 via the angled mirror 203, and to the desired thin-film filters 207 for coupling to the fiber 125.

The lens 209, which may comprise silicon, for example, focuses optical signals from the grating coupler beams via the lens array 201 into parallel collimated beams with a well selected beam waist to cover the total optical signal through the distance to the fiber 125. The mirror 203 may comprise a 45 degree total internal reflection mirror which makes the beams received from the lens array 201 horizontal, or vertical for signals received from the fiber 125.

The thin-film filters 207 may be configured to allow signals at certain wavelengths through while removing other wavelengths, with an array of thin-film filters thereby providing wavelength selection. The thickness and/or material of each filter may be configured for different wavelengths, such that each TFF 207 may be configured to allow a particular CWDM wavelength to pass.

In operation, a CWDM optical signal comprising a plurality of CWDM wavelength signals may be demultiplexed by coupling the signal from the fiber 125 into the optical assembly 200. The signal may be focused by the lens onto a first of the TFFs 207, where the signal at the pass wavelength of the first TFF will pass through while the remaining wavelengths reflect back to again be reflected towards the TFFs 207 by the back mirror 213 of the spacer 205C. The next of the TFFs 207 will allow the second wavelength CWDM signal to pass while reflecting the remaining wavelengths to the mirror 213, and again to the third TFF 207. Finally, the remaining CDWM wavelength signal will simply pass on to the spacer 205A. Each of the signals that pass through the TFFs 207, and the last remaining CWDM wavelength, are reflected downward into the lens array 201 for focusing onto grating couplers in the photonics die on which the optical assembly 200 is mounted.

While three TFFs 207 are shown, indicating four CWDM wavelength operation, other numbers are possible. In addition the optical assembly 200 can multiplex CWDM signals emitted from the chip on which the MUX/DEMUX assembly 200 is mounted. Each CWDM wavelength signal may be focused by the lens array 201 onto appropriate spots and width and desired shape to be reflected by the angled mirror 203 to the TFFs 207 via the spacer 205A. As with the demultiplexing process, the CWDM signals at the appropriate wavelength will pass through the TFF 207 configured for that wavelength and reflect off the mirror 213 and back to adjacent TFFs 207 for further reflection. This reflection back and forth continues until each signal is reflected off the first TFF 207 and into the lens 209, such that each wavelength signal from each light path is coupled into the spacer 205C, and subsequently to the lens 209 for focusing into the fiber 125.

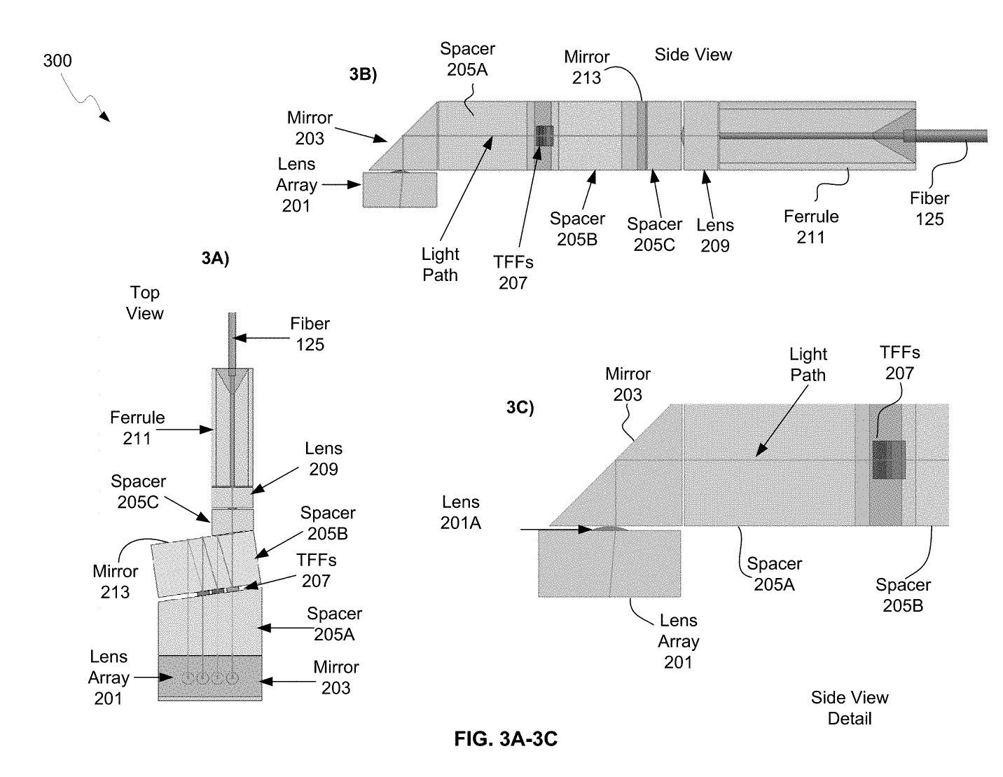

FIGS. 3A-3C illustrates top, side, and side detail views of a thin film filter external MUX/DEMUX for coupling to grating couplers on a photonic chip, in accordance with an example embodiment of the disclosure. Referring to FIG. 3A, there is shown a top view of the thin-film filter external MUX/DEMUX optical assembly 300 illustrating the paths of the different optical signals into respective grating couplers on the photonic IC. The MUX/DEMUX optical assembly 300 comprises a lens array 201, mirror 203, spacers 205A-205C, TFFs 207, lens 209, and ferrule 211.

FIG. 3A also illustrates the optical paths taken by the CWDM signals in either direction, into or out of the optical fiber. For example, a CWDM optical signal comprising four CWDM wavelength signals may be received in the optical assembly 300 via the fiber 125 and focused by the lens 209 onto the first TFF 207 via the spacer 205B, where the first CWDM wavelength, for which the first TFF 207 is configured, passes through while the remaining signals reflect back to the mirror 213 at the back surface of the spacer 205B, which are then reflected to the next TFF 207, and so on until the last CWDM wavelength signal merely passes through to the spacer 205A. Each signal that passes into the spacer 205A may then be reflected downward by the mirror 203 into the lens array 201 for focusing onto grating couplers in the photonic die to which the optical assembly 300 is coupled.

Similarly, the side views of FIGS. 3B and 3C illustrate the various components, such as the fiber 125, ferrule 211, spacers 205A-205C, thin-film filters 207, mirror 203, and lens array 201. As can be seen in the FIG. 3C, the lens array 201 may comprise convex lens structures 201A in contact with the total internal reflection mirror 203. Angle control in the spacers 205A-205C may be important for proper coupling of desired signals, and active alignment may be utilized for aligning to the grating coupler in the photonics chip (not shown) below the lens array 201 and for the fiber 125 to the assembly 300. The beam waist requirement based on throw distance may determine pitch and size.

Also, as can be seen in FIGS. 3B and 3C, the spacers 205A-205C may comprise a plurality of layers for thickness, alignment, index of refraction, and reflectivity control. The reflectivity of the back surface of the spacer 205B, adjacent to the lens 209, may be configured to reflect CWDM signals that were reflected by the TFFs 207 back to the TFFs 207 using the mirror 213. In this manner, CWDM signals that do not pass through a particular TFF 207, since such signals are outside of the pass-band, may be reflected to the next TFF 207. The light path, as indicated in FIGS. 3A and 3C, illustrate the reflection downward of optical signals received from the fiber 125, and/or reflection laterally for optical signals received from the lens array 201 below. In addition, the lens array 201 may focus the optical signals at an angle off-normal from the bottom surface of the lens array 201, and thus the top surface of the photonics die that receives the signals, for increased coupling efficiency.

In operation, a CWDM optical signal comprising a plurality of CWDM wavelength signals may be demultiplexed by coupling the signal from the fiber 125 into the optical assembly 300. The signal may be focused by the lens onto a first of the TFFs 207, where the signal at the pass wavelength of the first TFF will pass through while the remaining wavelengths reflect back to again be reflected towards the TFFs 207 by the back mirror 213 of the spacer 205C. The next of the TFFs will allow the second wavelength CWDM signal to pass while reflecting the remaining wavelengths to the mirror 213, and again to the third TFF 207. Finally, the remaining CDWM wavelength signal will simply pass on to the spacer 205A. Each of the signals that pass through the TFFs 207, and the last remaining CWDM wavelength, are reflected downward into the lens array 201 for focusing onto grating couplers in the photonics die on which the assembly 300 is mounted.

While three TFFs 207 are shown, indicating four CWDM wavelength operation, other numbers are possible. In addition the optical assembly 300 can multiplex CWDM signals emitted from the chip on which the MUX/DEMUX assembly 300 is mounted. Each CWDM wavelength signal may be focused by the lens array 201 onto appropriate spots with desired beam width and shape to be reflected by the mirror 203 to the TFFs 207 via the spacer 205A. As with the demultiplexing process, the CWDM signals at the appropriate wavelength will pass through the TFF 207 configured for that wavelength and reflect off the mirror 213 and back to adjacent TFFs 207 for further reflection. This reflection back and forth continues until each signal is reflected off the first TFF 207 and into the lens 209, such that each wavelength signal from each light path is coupled into the spacer 205C, and subsequently to the lens 209 for focusing into the fiber 125.

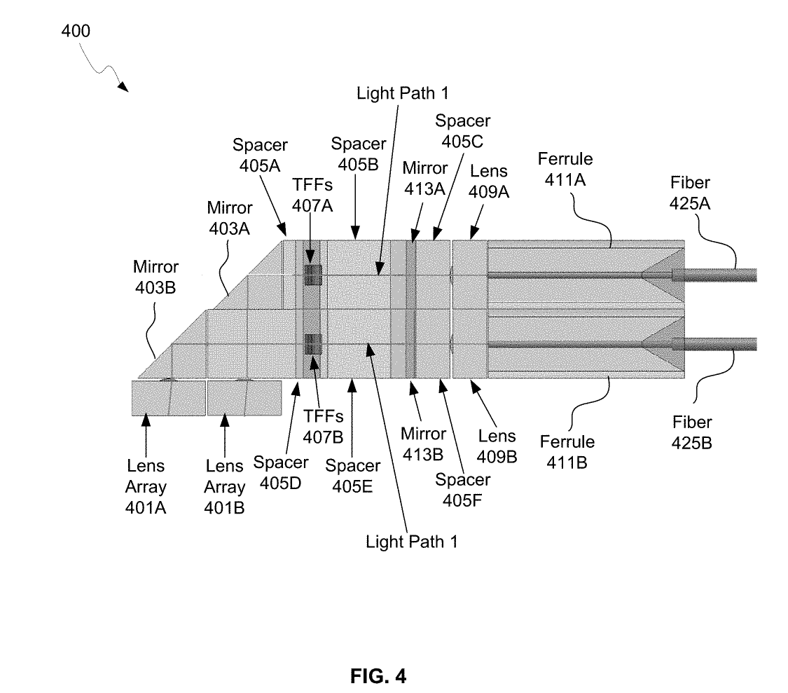

FIG. 4 illustrates a thin-film filter external MUX/DEMUX with both horizontal and vertical plane channel separation, in accordance with an example embodiment of the disclosure. Referring to FIG. 4, there is shown an external MUX/DEMUX optical assembly 400 comprising lens arrays 401A and 401B, mirrors 403A and 403B, spacers 405A-405D, TFFs 407A and 407B, lenses 409A and 409B, ferrules 411A and 411B, and mirrors 413A and 413B. There is also shown a pair of optical fibers 425A and 425B. In this example, the dual optical paths, shown by Light Path 1 and Light Path 2, enable channels separated in the horizontal direction, at the die surface, using thin-film filters and related optics, as well as vertical separation of channels using a plurality of optical fibers, such as fibers 425A and 425B.

The optical elements may be similar to those described previously, but with parallel paths displaced in the vertical direction as indicated by the space between the optical fibers 425A and 425B, and horizontally as indicated by the horizontal distance between the lens arrays 401A and 401B.

In the embodiment shown, the mirrors 403A and 403B reflect optical signals from, or to, fibers separated in the vertical direction as well as optical signals separated horizontally via the TFFs 407A and 407B and mirrors 413A and 413B, as illustrated in the top view of FIG. 3A. The reflected signals may be communicated into the lens arrays 401A and 401B for coupling to corresponding grating couplers in the photonic IC, or in the outgoing direction, may receive optical signals from the grating couplers in the photonic IC and couple signals to the TFFs 407A and 407B for coupling to corresponding fibers 425A and 425B in the ferrules 411A and 411B.

In operation, CWDM optical signals, each comprising a plurality of CWDM wavelength signals, may be demultiplexed by coupling the signals from the fibers 425A and 425B into the optical assembly 400. The signals may be focused by the lenses 409A and 409B onto a first of each set of TFFs 407A and 407B, where the signal at the pass wavelength of the first of each set of TFFs 407A and 407B will pass through while the remaining wavelengths reflect back to again be reflected towards the remaining TFFs 407A and 407B by the back mirrors 413A and 413B. The next TFF of each set of the TFFs 407A and 407B allows the second wavelength CWDM signal to pass while reflecting the remaining wavelengths to the mirrors 413A and 413B, and again to the third of each set of TFFs 407 and 407B. Finally, the remaining CWDM wavelength signal will simply pass on to the spacers 405A and 405D. Each of the signals that pass through the TFFs 407A and 407B, and the last remaining CWDM wavelength in each path, are reflected downward into the lens arrays 401A and 401B for focusing onto grating couplers in the photonics die on which the optical assembly 400 is mounted. While two sets of three TFFs 407A and 407B are described in this example, indicating dual four channel CWDM or eight channel CWDM operation, other numbers of channels are possible.

The optical assembly 400 may also multiplex CWDM signals emitted from the chip on which the MUX/DEMUX assembly 400 is mounted. Each CWDM wavelength signal may be focused by the lens arrays 401A and 401B onto appropriate spots with desired beam width and shape to be reflected by the mirrors 403A and 403B to the TFFs 407A and 407B via the spacers 405A and 405D. As with the demultiplexing process, the CWDM signals at the appropriate wavelength will pass through the TFF 407A and 407B configured for that wavelength and reflect off the mirrors 413A and 413B back to adjacent TFFs 407A and 407B for further reflection. This reflection back and forth continues until each signal is reflected off the first TFF 407A or 407B and into the lens 409A or 409B, such that each wavelength signal from each light path is coupled into the spacers 405C and 405F, and subsequently to the lenses 409A and 409B for focusing into the fiber 125.

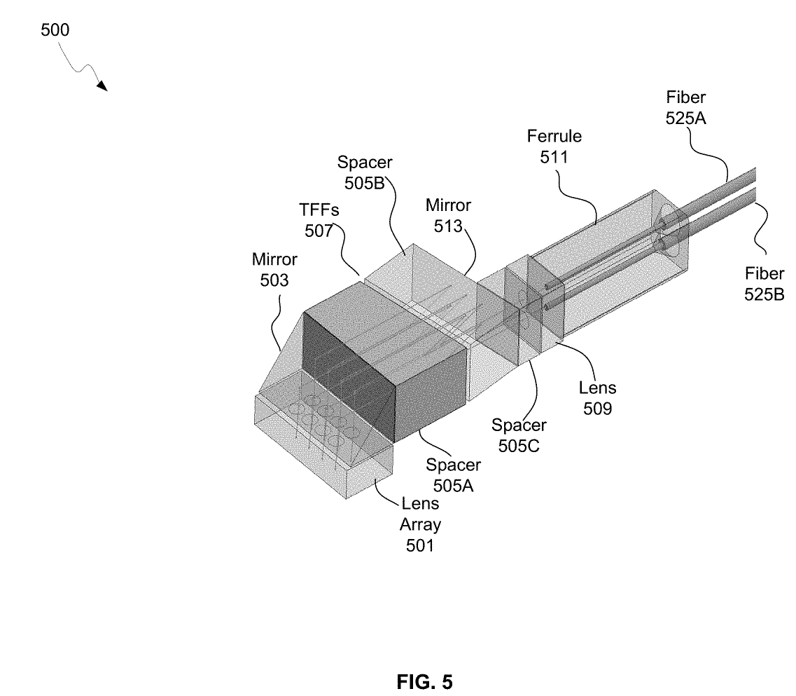

FIG. 5 illustrates an oblique view of a thin-film filter external MUX/DEMUX with both horizontal and vertical plane channel separation, in accordance with an example embodiment of the disclosure. Referring to FIG. 5, there is shown an external MUX/DEMUX 500 comprising lens arrays 501, mirror 503, spacers 505A-505C, TFFs 507, lens 509, ferrule 511, and mirror 513. There is also shown a pair of optical fibers 525A and 525B. In this example, the dual vertically separated optical paths enable channels separated in the vertical direction and horizontal separation at the die surface, using thin-film filters and related optics.

The optical elements may be similar to those described previously, with parallel paths displaced in the vertical direction as indicated by the space between the optical fibers 525A and 525B, and horizontally as indicated by the horizontal distance between the lens arrays 501A and 501B.

In this example, the channels are separated in the horizontal direction using thin-film filters and related optics, and vertically separated with a plurality of optical fibers. In the example shown in FIG. 5, there are two fibers aligned vertically.

In the embodiment shown, the mirror 503 is large enough to reflect optical signals from, or to, fibers 525A and 525B separated in the vertical direction as well as optical signals separated horizontally via the thin-film filters 507. The reflected signals may be communicated into the lens array 501 for coupling to corresponding grating couplers in the photonic IC, or, in the outgoing direction, may receive optical signals from the grating couplers in the photonic IC and couple signals to the thin-film filters 507 for coupling to corresponding fibers 525A and 525B in the ferrule 511.

In operation, CWDM optical signals, each comprising a plurality of CWDM wavelength signals, may be demultiplexed by coupling the signals from the fibers 525A and 525B into the optical assembly 500. The signals may be focused by the lens 509 onto a first of each set of TFFs 507, each set being displaced vertically from the other set. The signal at the pass wavelength of the first of each set of TFFs 507 will pass through while the remaining wavelengths reflect back to again be reflected by the mirror 513 towards the remaining TFFs 507. The next TFF of each set of the TFFs 507 allows the second wavelength CWDM signal to pass while reflecting the remaining wavelengths to the mirror 513, and again to the third of each set of TFFs 507. Finally, the remaining CWDM wavelength signal will simply pass on to the spacer 505A. Each of the signals that pass through the TFFs 507, and the last remaining CWDM wavelength in each path, are reflected downward into the lens array 501 for focusing onto grating couplers in the photonics die on which the optical assembly 500 is mounted. While two vertically displaced rows of three TFFs 507 are described in this example, indicating dual four channel CWDM or eight channel CWDM operation, other numbers of channels are possible.

The optical assembly 500 may also multiplex CWDM signals emitted from the chip on which the MUX/DEMUX assembly 500 is mounted. Each CWDM wavelength signal may be focused by the lens array 501 onto appropriate spots with desired beam width and shape to be reflected by the mirror 503 to the TFFs 507 via the spacer 505A. As with the demultiplexing process, the CWDM signals at the appropriate wavelength will pass through the TFF 507 configured for that wavelength and reflect off the mirror 513 back to adjacent TFFs 507 for further reflection. This reflection back and forth continues until each signal is reflected off the first TFF 507 and into the lens 509, such that each wavelength signal from each light path is coupled into the spacer 505C, and subsequently to the lens 509 for focusing into the fibers 525A or 525B.

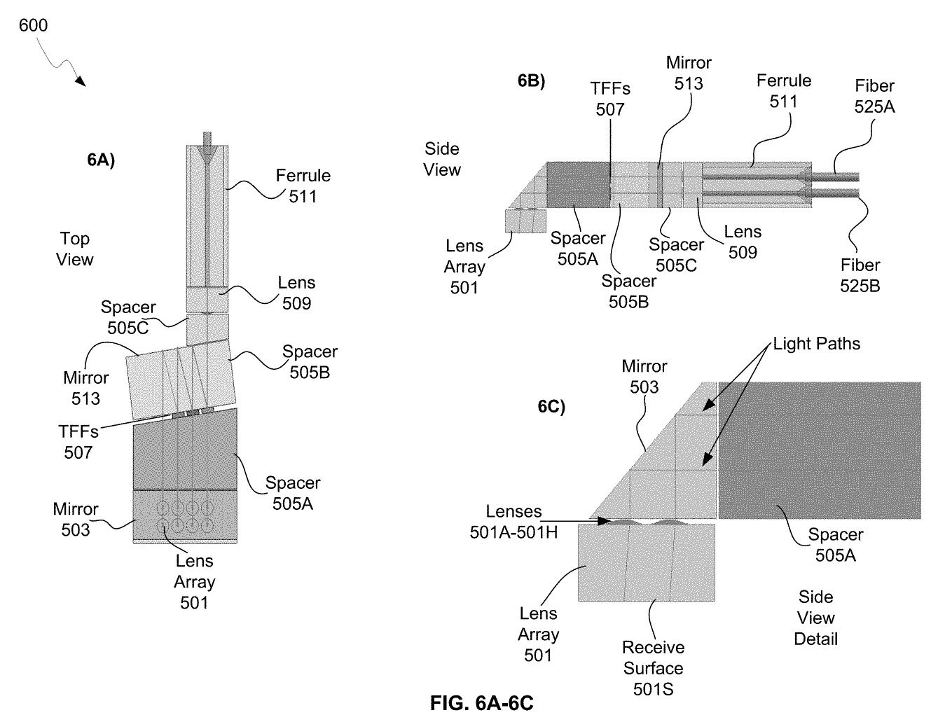

FIGS. 6A-6C illustrates top and side views of a thin-film filter external MUX/DEMUX with both horizontal and vertical plane channel separation, in accordance with an example embodiment of the disclosure. Referring to FIGS. 6A-6C, there is shown an external MUX/DEMUX 600 with channels separated in the horizontal direction using thin-film filters 507 and related optics, as well as vertical separation with a plurality of optical fibers. In the example shown in FIGS. 6A-6C, there are two fibers 525A and 525B aligned vertically.

In the embodiment shown, the mirror 503 is large enough to reflect optical signals from, or to, fibers 525A and 525B separated in the vertical direction as well as optical signals separated horizontally via the thin-film filters 507. The reflected signals may be communicated into the lens array 501 for coupling to corresponding grating couplers in the photonic IC, or, in the outgoing direction, may receive optical signals from the grating couplers in the photonic IC via the receive surface 501S and couple signals to the thin-film filters in a direction parallel to the receive surface 501S for coupling to corresponding fibers in the ferrule. The side view detail illustrates the convex lens structures 501A-501H that may be used in the lens array 501.

FIG. 6A illustrates the light paths of the CWDM signals that either pass through an individual TFF 507 or reflect back into the spacer 505B to be reflected by the mirror 513 back to the remaining TFFs 507. FIG. 6C illustrates the vertical displacement of light paths, reflected down by the mirror 503 in DEMUX operation, or reflected horizontally in MUX operation.

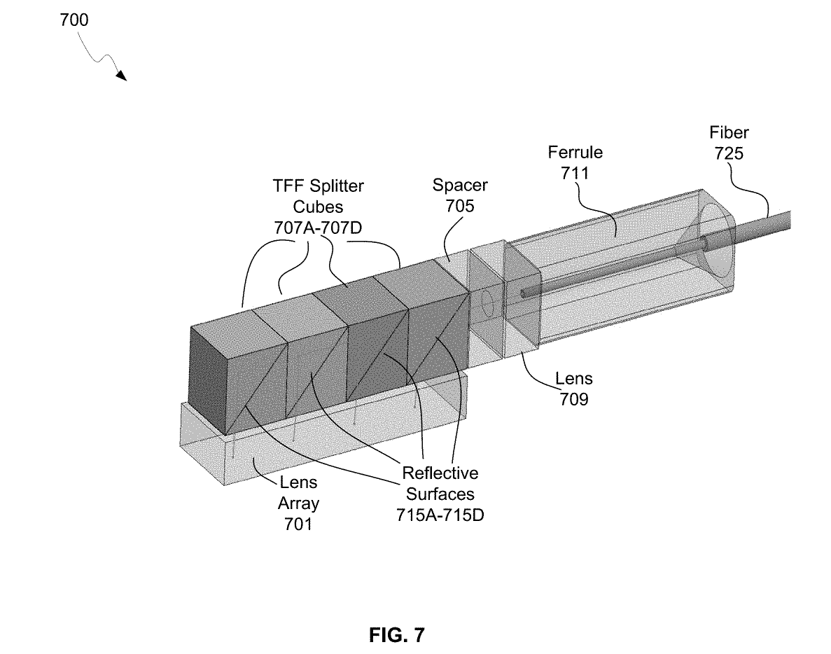

FIG. 7 illustrates a free-space MUX/DEMUX with thin film filter splitter cubes, in accordance with an example embodiment of the disclosure. Referring to FIG. 7, there is shown a MUX/DEMUX 700 comprising a fiber ferrule 711, a lens 709, a transparent spacer 705, an array of TFF beam splitter cubes 707A-707D with internal reflection surfaces 715A-715D and a lens array 701. The fiber ferrule 711 may comprise a mechanical structure for affixing a fiber to the MUX/DEMUX assembly, and may be coupled to lens 709, which may comprise silicon, for example, for focusing light from the fiber 725 onto the TFF splitter cubes 707A-707D via the spacer 705, or for focusing optical signals received from the TFF splitter cubes 707A-707D via the lens array 701 and into the fiber 725.

The spacer 705, which may comprise glass, for example, coupled to the fiber ferrule 711 may comprise a partially coated backside with a high reflectivity mirror to eliminate back-coupling of signals into the fiber 725. The silicon lens 709 focuses optical signals from the grating coupler beams into parallel collimated beams with a well selected beam waist to cover the total optical signal through the distance to the fiber 725.

The TFF beam splitter cubes 707A-707D may be configured to allow signals through at certain wavelengths while removing other wavelengths, with the array of TFF splitter blocks 707A-707D thereby providing wavelength selection, each one reflecting the associated wavelength optical signal down to the lens array. The thickness and/or material of each filter may be configured for different wavelengths. As the angle of incidence of incoming light on the TFF increases, the bandpass wavelengths become more sensitive to angle. This can be mitigated with proper material selection, such as with higher index of refraction, for example. The spacer 705 may have precise angles and thicknesses for directing optical signals to desired lenses in the lens array 701, and to the thin-film filter beam splitter cubes for coupling to the fiber.

The embodiment shown in FIG. 7 enables a more compact MUX/DEMUX with the additional advantage of a shorter optical path length, which allows significant reduction in size and hence also smaller beam waists enabling higher density of packing optical channels. This can be beneficial for very high throughput optical transceiver units.

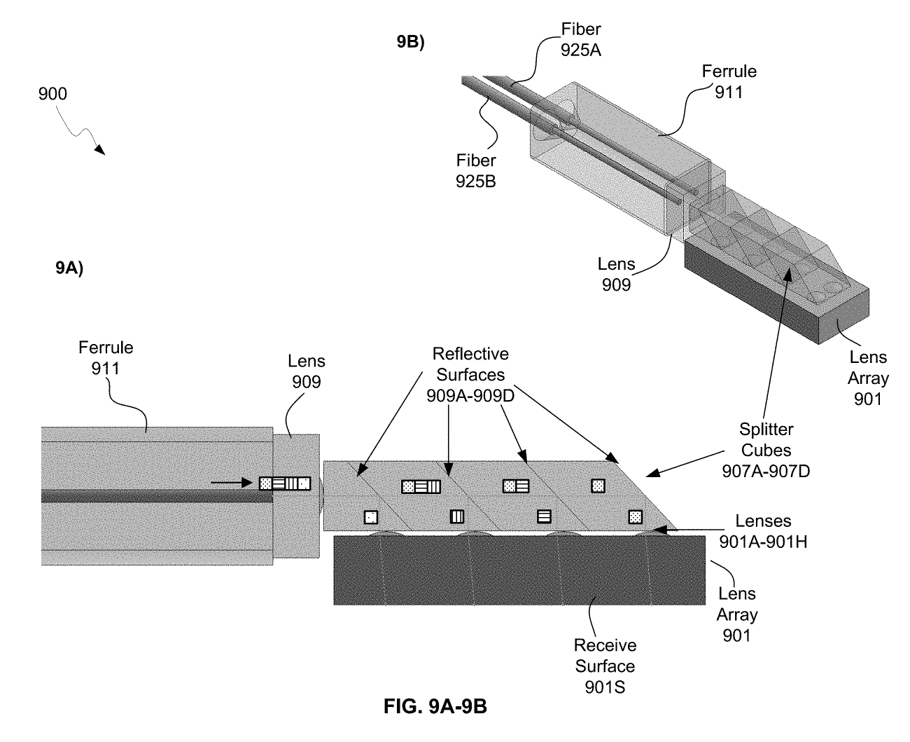

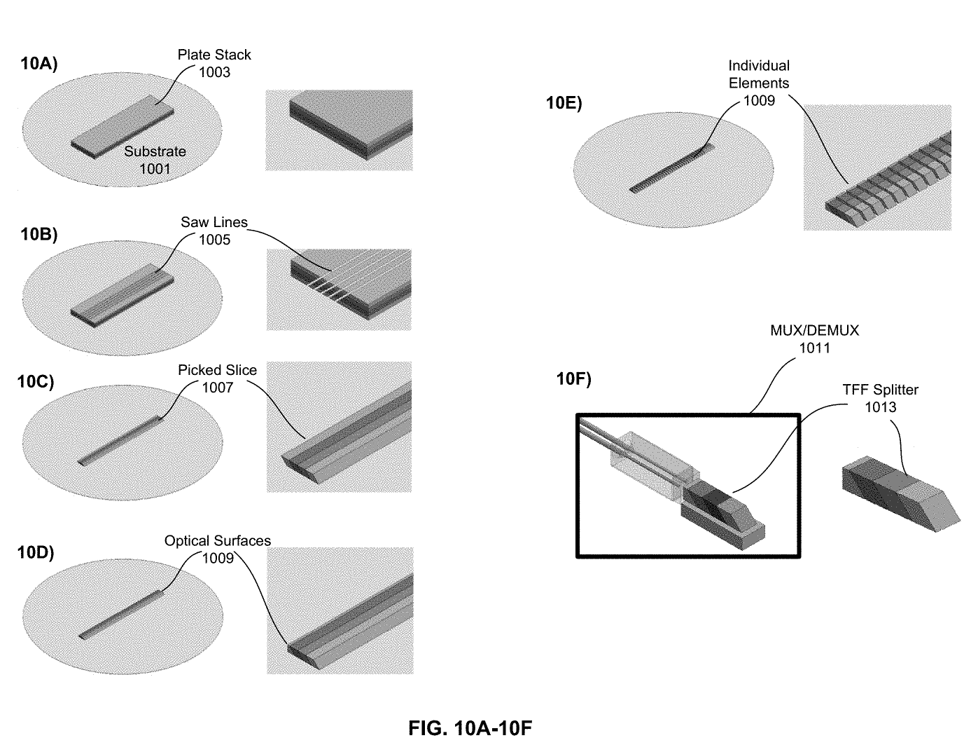

In an example embodiment, each of the TFF splitter cubes 707A-707D reflects a specific CWDM channel wavelength downward while allowing other wavelengths to pass through. This may be enabled by allowing all wavelengths up to a desired wavelength to pass through the material of the TFF splitter cubes and the reflective surfaces 715A-715D are tuned to reflect particular wavelengths. While cubic structures are shown in FIG. 7, other shapes are possible, such as rectangular shapes, or rounded edge shapes. For example, a rectangular prism shaped with sloped sides is shown in FIGS. 9A-9B and 10A-10F.

Because the optical elements of the MUX/DEMUX can be arranged longitudinally on the photonics die with very small pitch, beam separation can happen by simple propagation and can give very short throw distance requirements. In this embodiment, the 45 degree reflection is combined with the filtering function to eliminate the additional mirror, which also readily allows using the same filter stack for the MUX and DEMUX with no additional components. Other advantages of the structure disclosed in FIG. 7 include improved axial loss in the collimated section due to divergence, since the beam waist of each channel occurs at a different spot. The more compact the device is, i.e., smaller propagation difference between successive channels, the higher the tolerable divergence. In addition, angular misalignment in the collimated section may be reduced, which translates to reduced lateral misalignment at the single-mode apertures (GCs/SMFs). The larger the collimated beam size, the higher the angular loss sensitivity, so more compact solutions such as that of FIG. 7 are favorable since they require smaller collimated beams.

Another improvement is in lateral misalignment in the collimated section, which gives angle errors at the single-mode apertures (GCs/SMFs). Specifically, an effective “pitch error” of the filters due to physical tolerances or incorrect beam angles is improved due to the smaller size. Finally, filter losses are reduced in smaller structures—example TFF reflection efficiency from each filter is ˜99%, and the transmission through a filter is 95%, which may be improved with further filter optimization.

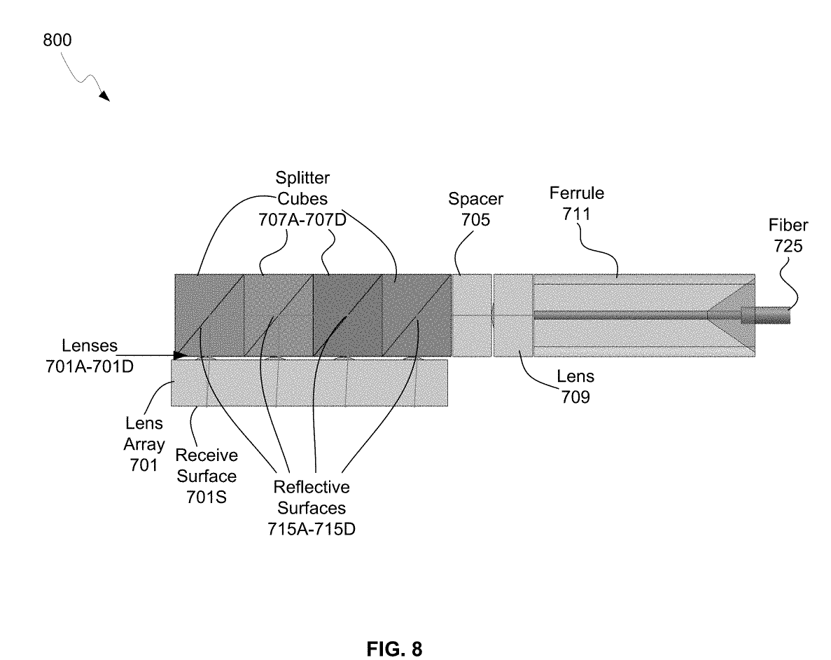

FIG. 8 illustrates a side view of a free-space MUX/DEMUX with thin film filters, in accordance with an example embodiment of the disclosure. Referring to FIG. 8, there is shown a MUX/DEMUX 800 comprising fiber ferrule 711, lens 709, spacer 705, an array of thin-film filter beam splitter cubes 707A-707D with internal reflection surfaces 715A-715D, and lens array 701, each as shown and described with respect to FIG. 7. As can be seen from the side view, optical signals from the fiber may be focused by the lens 709 and coupled by the spacer 705 to the array of thin-film filter blocks 707A-707D, thereby providing wavelength selection, each one reflecting the associated wavelength optical signal down to the lens array 701, which then focuses the optical signals into grating couplers of the photonics chip on which the lens array 701 is mounted. As the angle of incidence of incoming light on the TFF increases, the bandpass wavelengths become more sensitive to angle. This can be mitigated with proper material selection, such as with higher index of refraction, for example. The side view detail illustrates the convex lens structures 701A-701H that may be used in the lens array 701.

In MUX operation, optical signals at different CWDM wavelengths, four in this example, may be received via the lens array 701 through receive surface 701S from grating couplers in the photonic chip to which the MUX/DEMUX 800 may be coupled. The optical signals may be focused by the lens array 701 onto the reflective surfaces 715A-715D in the TFF splitter cubes 707A-707D, reflected in a direction parallel to the receive surface 701S into the spacer 705, thereby communicating a multiplexed CWDM signal, which is then focused by the lens 709 into the fiber 725.

FIGS. 9A-9B illustrate side and oblique angle views of a free-space MUX/DEMUX with angled facet thin film filter splitter cubes, in accordance with an example embodiment of the disclosure. Referring to FIGS. 9A and 9B, there is shown MUX/DEMUX 900 comprising a lens array 901, TFF splitter cubes 907A-907D, lens 909, and a ferrule 911. Optical fibers 925A and 925B may be coupled to the MUX/DEMUX 900 using the ferrule 911. The side view detail illustrates the convex lens structures 901A-901H that may be used in the lens array 901.

The TFF splitter cubes 907A-907D may be a rectangular prism shape, where angled surfaces are formed to provide the angled reflective surfaces 909A-909D for reflecting optical signals down into the lens array, or to reflect signals from the lens array 901 into the lens 909. The reflective surfaces 909A-909D may comprise thin film filters tuned to the specific wavelength for that TDD splitter cube 907A-907D. As the angle of incidence of incoming light on the TFF increases, the bandpass wavelengths become more sensitive to angle. This can be mitigated with proper material selection, such as with higher index of refraction, for example.

The different patterned squares in the splitter cubes 907A-907D in FIG. 9A indicate different wavelength CWDM signals that are reflected by each TFF splitter cube. In instances when optical signals are received via the lens array 901, such as from grating couplers in the photonic chip to which the assembly 900 may be coupled, the optical signals may be reflected by the reflective surfaces 909A-909D in a direction perpendicular to the receive surface 901S, which may be parallel to the photonic chip surface.

FIGS. 10A-10F illustrate an example process for fabricating angled thin film filter splitters, in accordance with an example embodiment of the disclosure. FIG. 10A shows a plate stack 1003 bonded to a substrate 1001. The stacked plate 1003 may comprise coated plates where the coating on each plate comprises a thin film filter that is configured for a desired wavelength.

FIG. 10B illustrates saw lines 1005 in the stacked plate, where the lines are at a 45 degree angle, for example, for reflecting optical signals perpendicularly to the plane of incidence of an incoming optical signal. FIG. 10C illustrates a picked slice 1007 defined by the saw lines 1005 including two perpendicular say lines outside of the 45 degree cut saw lines 1005.

FIG. 10D illustrates the exposed surfaces following polishing and/or grinding to create optical surfaces 1009, or a surface that is smooth at optical wavelengths without excessive scattering. FIG. 10E shows individual elements 1009 after the picked slice 1007 has been further sawn perpendicular to the length of the slice 1007. These individual elements 1009 may be further polished if desired, resulting in the TFF splitter 1013 for incorporation into the MUX/DEMUX 1011 shown in FIG. 10F, and as also shown by MUX/DEMUX 800 and 900 in FIGS. 8 and 9.

In an example embodiment of the disclosure, a method and system is described for a free space CWDM MUX/DEMUX for integration with a grating coupler based silicon platform. The system may comprise an optical assembly coupled to a top surface of a photonic chip, where the optical assembly comprises a lens array on the top surface of the photonic chip and a plurality of thin film filter splitters having angled reflective surfaces. In an example embodiment, the optical assembly may be coupled to the top surface of the photonic chip.

The optical assembly may be operable to receive an input optical signal comprising a plurality of optical signals at different wavelengths via an optical fiber coupled to the optical assembly, focus the input optical signal onto a first of the plurality of thin film filter splitters, reflect a first of the plurality of optical signals into the lens array and passing others of the plurality of optical signals to a second of the plurality of thin film filter splitters, and reflect a second of the plurality of optical signals into the lens array and passing others of the plurality of optical signals to a third of the plurality of thin film filter splitters.

The optical assembly may be operable to focus the optical signal received from the optical fiber onto the first of the plurality of thin film filters using a silicon lens. Each of the plurality of thin film filter splitters may be configured to reflect a different wavelength. Each thin film filter splitter may be coupled above one or more lenses of the lens array. The optical assembly may be operable to receive a second input optical signal via a second optical fiber coupled to the optical assembly. The angled reflective surfaces may comprise thin film filters.

In another example embodiment of the disclosure, a method and system is described for a free space CWDM MUX/DEMUX for integration with a grating coupler based silicon platform. The system may comprise an optical assembly comprising a lens array and a plurality of thin film filter splitters having angled reflective surfaces.

The optical assembly may be operable to receive a plurality of optical signals at different wavelengths from via the lens array, reflect each of the plurality of optical signals in a direction parallel to a receiving surface of the lens array using the angled reflective surfaces of the thin film filter splitters, and generate a multiplexed output optical signal by focusing the reflected plurality of optical signals into an optical fiber coupled to the optical assembly. The optical assembly may be operable to focus the reflected plurality of optical signals into the optical fiber using a silicon lens. Each of the plurality of thin film filter splitters may be configured to reflect a different wavelength.

Each thin film filter splitter may be coupled above one or more lenses of the lens array. The optical assembly may be operable to generate a second multiplexed output optical signal for a second optical fiber coupled to the optical assembly by reflecting a second plurality of optical signals using a second plurality of thin film filter splitters. The angled reflective surfaces may comprise thin film filters.

While the present disclosure has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in an optical assembly, the optical assembly comprising a lens array and a plurality of thin film filter splitters having angled reflective surfaces:
receiving an input optical signal comprising a plurality of optical signals at different wavelengths via an optical fiber coupled to the optical assembly;
focusing the input optical signal onto a first of the plurality of thin film filter splitters;
reflecting a first of the plurality of optical signals into the lens array and passing others of the plurality of optical signals to a second of the plurality of thin film filter splitters; and
reflecting a second of the plurality of optical signals into the lens array and passing others of the plurality of optical signals to a third of the plurality of thin film filter splitters.

2. The method according to claim 1, comprising focusing the optical signal received from the optical fiber onto the first of the plurality of thin film filters using a silicon lens.

3. The method according to claim 1, wherein each of the plurality of thin film filter splitters is configured to reflect a different wavelength.

4. The method according to claim 1, wherein each thin film filter splitter is coupled above one or more lenses of the lens array.

5. The method according to claim 1, comprising receiving a second input optical signal via a second optical fiber coupled to the optical assembly.

6. The method according to claim 1, wherein the angled reflective surfaces comprise thin film filters.

7. A system for communication, the system comprising:
an optical assembly comprising a lens array and a plurality of thin film filter splitters having angled reflective surfaces, the optical assembly being operable to:
receive an input optical signal comprising a plurality of optical signals at different wavelengths via an optical fiber coupled to the optical assembly;
focus the input optical signal onto a first of the plurality of thin film filter splitters;
reflect a first of the plurality of optical signals into the lens array and passing others of the plurality of optical signals to a second of the plurality of thin film filter splitters; and
reflect a second of the plurality of optical signals into the lens array and passing others of the plurality of optical signals to a third of the plurality of thin film filter splitters.

8. The system according to claim 7, wherein the optical assembly is operable to focus the optical signal received from the optical fiber onto the first of the plurality of thin film filters using a silicon lens.

9. The system according to claim 7, wherein each of the plurality of thin film filter splitters is configured to reflect a different wavelength.

10. The system according to claim 7, wherein each thin film filter splitter is coupled above one or more lenses of the lens array.

11. The system according to claim 7, wherein the optical assembly is operable to receive a second input optical signal via a second optical fiber coupled to the optical assembly.

12. The system according to claim 7, wherein the angled reflective surfaces comprise thin film filters.

13. A method for communication, the method comprising:
in an optical assembly comprising a lens array and a plurality of thin film filter splitters having angled reflective surfaces:
receiving a plurality of optical signals at different wavelengths via the lens array;
reflecting each of the plurality of optical signals in a direction parallel to a receiving surface of the lens array using the angled reflective surfaces of the thin film filter splitters; and
generating a multiplexed output optical signal by focusing the reflected plurality of optical signals into an optical fiber coupled to the optical assembly.

14. The method according to claim 13, comprising focusing the reflected plurality of optical signals into the optical fiber using a silicon lens.

15. The method according to claim 13, wherein each of the plurality of thin film filter splitters is configured to reflect a different wavelength.

16. The method according to claim 13, wherein each thin film filter splitter is coupled above one or more lenses of the lens array.

17. The method according to claim 13, comprising generating a second multiplexed output optical signal for a second optical fiber coupled to the optical assembly by reflecting a second plurality of optical signals using a second plurality of thin film filter splitters.

18. The method according to claim 13, wherein the angled reflective surfaces comprise thin film filters.

19. A system for communication, the system comprising:
an optical assembly comprising a lens array and a plurality of thin film filter splitters having angled reflective surfaces, the optical assembly being operable to:
receive a plurality of optical signals at different wavelengths via the lens array;
reflect each of the plurality of optical signals in a direction parallel to a receiving surface of the lens array using the angled reflective surfaces of the thin film filter splitters; and
generate a multiplexed output optical signal by focusing the reflected plurality of optical signals into an optical fiber coupled to the optical assembly.

20. The system according to claim 19, wherein the optical assembly is operable to focus the reflected plurality of optical signals into the optical fiber using a silicon lens.

21. The system according to claim 19, wherein each of the plurality of thin film filter splitters is configured to reflect a different wavelength.

22. The system according to claim 19, wherein each thin film filter splitter is coupled above one or more lenses of the lens array.

23. The system according to claim 19, wherein the optical assembly is operable to generate a second multiplexed output optical signal for a second optical fiber coupled to the optical assembly by reflecting a second plurality of optical signals using a second plurality of thin film filter splitters.

24. The system according to claim 19, wherein the angled reflective surfaces comprise thin film filters.
